(19) United States
(12) Patent Application Publication
(10) Pub. No.: US 2012/0045623 A1
(43) Pub. Date: Feb. 23, 2012

(54) MEMBRANE ASSEMBLY AND METHOD OF INSTALLING ROOFING SYSTEM

(76) Inventors: Robert C Delaney, Carmel, IN (US); Bruce F. Douglas, Zionsville, IN (US); Norman Ninow, Noblesville, IN (US); L. Richard Peng, Fishers, IN (US); James Burkett, Perrysburg, OH (US)

(21) Appl. No.: 12/860,201

(22) Filed: Aug. 20, 2010

(51) Int. Cl. E04D 5/10; B32B 25/16; B32B 38/18; B32B 3/06

(52) U.S. Cl. 428/189; 428/411.1; 428/221; 428/324; 428/325; 156/192

(57) ABSTRACT

A roofing system including a roof deck and a membrane assembly secured to the roof deck. The roof deck may be a flammable roof deck. The membrane assembly includes a roofing membrane and a fire resistant sheet, the fire resistant sheet, or a portion thereof, secured to the membrane. The fire resistant sheet includes a fabric substrate and a binder.

### FIELD OF THE INVENTION

One or more embodiments of the present invention relate to a method of installing a roofing system. More particularly, one or more embodiments of the present invention relate to a method of installing a roofing system including a roofing membrane and a fire-resistant sheet by providing the membrane and fire-resistant sheet to the installation site in a single roll and positioning them over a roof deck simultaneously. Other embodiments of the present invention relate to a membrane assembly including a roofing membrane and a fire resistant sheet.

### BACKGROUND OF THE INVENTION

The construction industry commonly uses membranes to provide a waterproof barrier on flat or low slope roofs. It is prohibitively expensive and difficult to produce and transport a single membrane that is sized to cover an entire roof surface, thus, a plurality of individual membranes are provided and oriented in an overlapping arrangement. The overlapping portions, or splices, of these individual membranes must be secured together ensure that the plurality of membranes form a single waterproof surface.

In certain situations, particularly where a roofing membrane is installed over a wooden roof deck, a fire-resistant sheet is provided between the roof deck and the membrane to meet industry required fire-resistance standards. Conventional installation practice involves first providing a roll of fire-resistant sheet that is unrolled and positioned on the roof deck. After the fire-resistant sheet is in place, a roofing membrane is then unrolled and positioned over the fire-resistant sheet and secured to adjacent membranes. Mechanical fasteners may also be provided to secure the membrane and fire-resistant sheet to the roof deck.

The conventional installation method for roofing systems that include a fire-resistant sheet may be both time consuming and problematic. Care must be taken when unrolling and positioning the membrane over the fire-resistant sheet to avoid moving the fire-resistant sheet and creating gaps between adjacent fire-resistant sheets. These gaps could prevent the roofing system from meeting the fire resistance standards specified for the installation. In addition, separately unrolling and positioning the fire-resistant sheet and the roofing membrane may take considerable time.

Therefore, there is a need for an improved method of installing a roofing assembly including a fire-resistant sheet.

### SUMMARY OF THE INVENTION

One or more embodiments of the present invention provide a membrane assembly including: (a) a generally planar membrane having a top surface, a bottom surface, a first longitudinal edge and a second longitudinal edge; and (b) a generally planar fire-resistant sheet secured to the bottom surface of the roofing membrane, the fire resistant sheet including a fabric substrate and a binder having fire retardant fillers.

Other embodiments of the present invention provide a roofing system including (a) a wood roof deck; and (b) a membrane assembly secured to the roof deck, the membrane assembly including a roofing membrane and a fire-resistant sheet, the fire-resistant sheet being secured to the roofing membrane.

Still other embodiments of the present invention provide a method of installing a roofing system including (a) providing a rolled membrane assembly, the rolled membrane assembly including a roofing membrane and a fire-resistant sheet; (b) simultaneously positioning the roofing membrane and fire-resistant sheet on a roof deck by unrolling the membrane assembly so that the fire-resistant sheet is positioned between the roof deck and the roofing membrane; and (c) securing the membrane assembly to the roof deck to form a roofing system.

### BRIEF DESCRIPTION OF THE DRAWINGS

FIG. 1 is a fragmentary sectional view of a roofing assembly according to the concepts of the present invention;

FIG. 2 is a fragmentary perspective view of a membrane assembly according to the concepts of the present invention;

FIG. 3 is a fragmentary perspective view of a partially unrolled membrane assembly according to the concepts of the present invention; and

FIG. 4 is a fragmentary sectional view of a roofing system according to the concepts of the present invention including a lap seam formed between adjacent membranes.

### DETAILED DESCRIPTION OF THE ILLUSTRATIVE EMBODIMENTS

Embodiments of the invention are based upon the discovery of a membrane assembly that includes a water-impervious membrane in combination with a fire-resistant sheet. The combination of the membrane and fire-resistant sheet provides numerous advantages. For example, the assembly can be stored and shipped to an installation site in an efficient manner. And, during installation, the assembly allows for simultaneous installation of the membrane and fire-resistant sheet, which provides, among other benefits, savings in time, labor, and costs. Accordingly, embodiments of the present invention are directed toward a membrane assembly that includes a water-impervious membrane and a fire-resistant sheet, methods for manufacturing this assembly, and methods for installing this assembly on a roof top, as well as roofing systems that include the assembly.

### Roofing System

Embodiments of the present invention provide a roofing system including a fire-resistant sheet positioned adjacent to a roof deck, and a roofing membrane positioned over the fire-resistant sheet. The roofing membrane and fire-resistant sheet may be secured to the roof deck by conventional attachment mechanisms including, for example, by mechanical attachment. Similarly, adjacent roofing membranes may be joined together at lap seams by conventional methods or mechanisms, including, for example, the use of adhesive tapes or by heat welding.

Referring now to FIG. 1, a roof system formed by embodiments of the present invention is shown, and is generally indicated by the numeral 10. Roof system 10 includes a roof deck 12, which forms the outer most structural portion of the building on which the roofing system is positioned. In one or more embodiments, roof deck 12 may include any conventional roof decking materials, such as, for example, wood and metal. Embodiments of the present invention are particularly applicable to roofing systems including wooden roof decks, where fire resistance standards are more difficult to achieve due to the increased flammability of the decking, although practice of the present invention is not limited to installation over wooden roof decks. In one or more embodiments, an insulation layer (not shown) may be provided over roof deck 12. The insulation layer may be provided in any form known to those skilled in the art, and may be, for example, a polyisocyanurate foam board. In one or more embodiments, the insulation layer may be secured to roof deck 12 by any method known in the art, including by mechanical fasteners or with the use of adhesives.

In accordance with embodiments of this invention, roofing system 10 also includes a fire-resistant sheet 14 positioned directly over and in contact with roof deck 12. A roofing membrane 16 is positioned over and in contact with fire-resistant sheet 14 and forms the outer-most surface of the roofing system. Both fire-resistant sheet 14 and roofing membrane 16 may be provided in numerous pieces to the installation site. Thus, each is positioned adjacent to and may be secured to other fire-resistant sheets or roofing membranes so as to cover the entire roof deck 12.

### Membrane Assembly

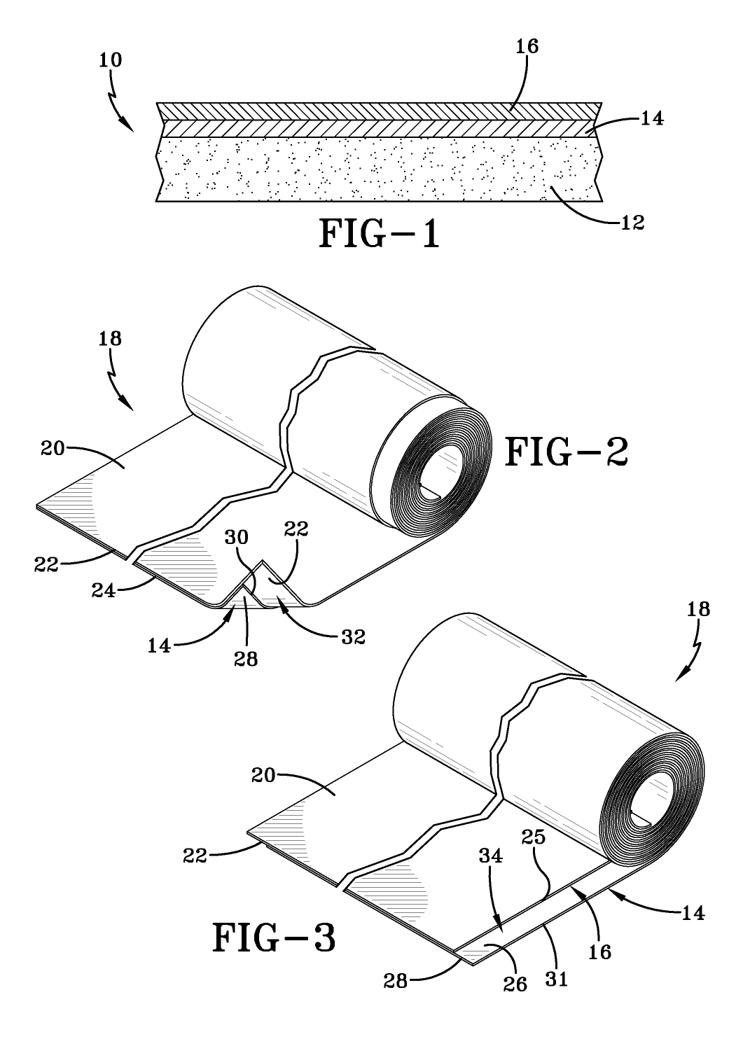

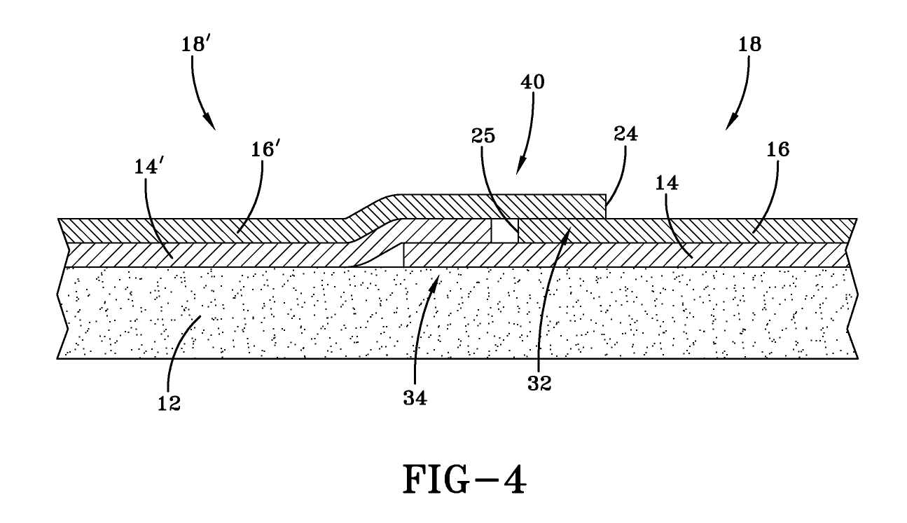

Referring now to FIG. 2, a roofing membrane assembly is shown and is generally indicated by the numeral 18. Roofing membrane assembly 18 includes roofing membrane 16 and fire-resistant sheet 14. Roofing membrane 16 includes a top surface 20, a bottom surface 22, a first longitudinal edge 24 and a second longitudinal edge 25 opposite first longitudinal edge 24. Fire-resistant sheet 14, or a portion thereof, may be secured to bottom surface 22 of roofing membrane 16. Fire-resistant 14 includes a top surface 26 (FIG. 3), a bottom surface 28, a first longitudinal edge 30 and a second longitudinal edge 31 opposite first longitudinal edge 30.

In certain embodiments, first longitudinal edge 24 of roofing membrane 16 and first longitudinal edge 30 of fire-resistant sheet 14 may be substantially aligned with one another along the length of the roofing membrane assembly 18 (not shown). Similarly, the second longitudinal edge 25 of roofing membrane 16 and the second longitudinal edge 31 of the fire-resistant sheet 14 may be substantially aligned along the length of the roofing membrane assembly 18 (FIG. 2). In other embodiments, first longitudinal edge 30 of fire-resistant sheet 14 may be off-set from first longitudinal edge 24 of roofing membrane 16 so that a portion 32 of bottom surface 22 of roofing membrane 16 is left exposed proximate first longitudinal edge 24 (FIG. 2). The exposed portion 32 of bottom surface 22 facilitates the formation of lap seams between adjacent roofing membrane assemblies during installation of the roofing system. Exposed portion 32 may have a width in a direction generally perpendicular to first longitudinal edge 24 of between approximately 2.0 inches and 12.0 inches.

In one or more embodiments, and as shown in FIG. 2, exposed portion 32 of bottom surface 22 may be created by providing a fire-resistant sheet 14 that has a width that is less than the width of roofing membrane 16. For example, in certain embodiments roofing membrane 16 may have a width of approximately 10.0 feet, and fire-resistant sheet 14 may have a width of approximately 9.5 feet. The second longitudinal edge 25, 31 of both roofing membrane 16 and fire-resistant sheet 14 may be aligned along the length of the roofing membrane assembly 18, leaving an exposed portion 32 adjacent to first longitudinal edge 24 having a width of approximately 6 inches.

In other embodiments, and as shown in FIG. 3, exposed portion 32 of bottom surface 22 may be created by staggering fire-resistant sheet 14 relative to roofing membrane 16 in the transverse direction. Thus, a trailing portion 34 of fire-resistant sheet 14 may extend from under roofing membrane 16 along the second longitudinal edge 25 of roofing membrane 16. The width of the trailing portion 34 of fire-resistant sheet 14 along the second longitudinal edge 25 of roofing membrane 16 is equal to the width of exposed portion 32 of bottom surface 22 that is created by the stagger.

### Roofing Membrane

Practice of the present invention is not necessarily limited by the selection of a particular water-impervious membrane, which may also be referred to as roofing membrane 16. As is known in the art, numerous roofing membranes are commercially used including polymeric and asphaltic membranes. Useful polymeric membranes include thermoset and thermoplastic roofing membranes.

Thermoplastic roofing membranes may include thermoplastic polymers such as polyvinylchloride resins (e.g. PVC) or polyolefin resins (e.g. TPO). These membranes often include stabilizers and/or flame retardants. The use of these materials for roofing membranes is known in the art as described in U.S. Pat. Nos. 6,502,360, 6,743,864, 6,543,199, 5,725,711, 5,516,829, 5,512,118, and 5,486,249, as well as co-pending U.S. Ser. No. 60/712,070, which are incorporated herein by reference. For example, useful reactor copolymers are disclosed in U.S. Pat. No. 6,451,897, which is incorporated herein by reference. In other embodiments, blends of polyolefins may be employed such as those disclosed in U.S. Publication No. 2009/0137168, which is incorporated herein by reference. In one or more embodiments, the thermoplastic membranes include those membranes that meet the specifications of ASTM D 4637-03, ASTM 6878-03, and/or ASTM D1418-85).

Useful thermoplastic membranes are commercially available. For example, they can be obtained under the tradenames UltraPly™ and ReflexEON™ (Firestone Building Products).

In other embodiments, the membrane may include thermoset polymers such as poly(ethylene-co-propylene-co-diene) terpolymer rubber or poly(ethylene-co-propylene) copolymer rubber or crosslinked derivatives thereof, which may be referred to as EPDM or EPM membranes. These membranes include those defined meeting the performance specifications provided in ASTM-D-1418-85 and/or ASTM-4637-03. EPDM membranes may be cured by using a curative in the formulation, optionally in conjunction with various accelerators, the combination of which is often referred to as a cure package. These membranes may also include extender oils, processing aids such as various metal salts of stearic acid, sodium dodecyl sulfate as well as tackifying resins, plasticizers, antioxidants, antiozonants, waxes, cure accelerators, zinc oxide, stearic acid, UV stabilizers, and the like, all in conventional amounts as known. Roofing membranes made from these materials are described in U.S. Pat. Nos. 6,632,509, 6,615,892, 5,700,538, 5703,154, 5,804,661, 5,854,327, 5,093,206, and 5,468,550, which are incorporated herein by reference.

Commercially available thermoset roofing membranes may include elastomeric copolymers such as ethylene-propylene-diene copolymer (EPDM) rubber and functionalized olefins such as chlorosulfonated polyethylene (CSPE). For example, EPDM membranes are available under the tradename RubberGard™, RubberGard Platinum™, RubberGard EcoWhite™, and RubberGard MAX™ (Firestone Building Products).

### Fire-Resistant Sheet

In one or more embodiments, fire-resistant sheet 14 may include a fabric substrate. The fabric substrate may include a woven or nonwoven mat or fabric. These fabrics may be prepared from, for example, polyester fibers, glass fibers, cellulosic fibers, asbestos, steel fibers, alumina fibers, ceramic fibers, nylon fibers, graphite fibers, wool fibers, boron fibers, carbon fibers, jute fibers, polyolefin fibers, polystyrene fibers, acrylic fibers, phenol-formaldehyde resin fibers, aromatic and aliphatic polyamide fibers, polyacrylamide fibers, or mixtures thereof which may include bi-component fibers or multi-component fibers. In one or more embodiments, fiberglass filaments may be provided in a synthetic non-woven mat in the machine direction to improve dimensional strength. In other embodiments, the substrate may include a composite prepared from a woven and nonwoven fabric. In other embodiments, the substrate may include a composite prepared from multiple nonwoven fabrics. As is known in the art, two or more fabrics can be formed into a composite by employing techniques such as needle punching.

In one or more embodiments, sheet 14 may also include a binder. In other words, the fabric substrate is coated, impregnated, or otherwise treated with a binder composition. For example, the fabric may be coated on one or both of its planar sides with a binder composition. As is generally known in the art, the binder composition may include a polymer (which itself may be referred to as a binder) and a filler. In one or more embodiments, the polymer of the coating composition forms a matrix in which the filler is dispersed. Useful polymers may include acrylics, syrene-acrylics, styrene-butadines, styrene-butadine-acrylics, butyl rubbers, polychloroprene, vinylchloride copolymers, polyvinyl alcohol, nitrile rubber, polyvinyl acetate copolymers, acrylic latex binder, butyl rubber latex, SBR latex, neoprene latex, and polyvinyl alcohol emulsion and elastomers.

As is generally known in the art, the binder composition that is used to treat the fabric (and ultimately provide a coating to the fabric) may be in the form of a latex or a solution in which the filler is dispersed or dissolved. For example, a filler may be dispersed in an acrylic latex, which is then applied to the fabric.

In one or more embodiments, the binder may include any known fillers to improve the physical or performance characteristics of sheet 14. In certain embodiments, the binder may include fire retardant fillers such as, for example, fly ash, clay decabromo-diphenyloxide, antimony trioxide, charged calcium carbonate, 3-X mineralite mica, glass or ceramic microspheres, or combinations thereof. Clay fillers may include any one of or a combination of soft clay, hard clay, and amino silane treated clay.

### Method of Manufacturing Membrane Assembly

According to embodiments of the present invention, an assembly is provided by rolling a roofing membrane and a fire-resistant sheet together to form a rolled assembly. In one or more embodiments, the fire-resistant sheet and the roofing membrane may be secured to each other before or during the rolling process. In one or more embodiments, the fire-resistant sheet and the roofing membrane may be staggered to provide a selvage edge to facilitate the creation of lap seems during installation.

In one or more embodiments, fire-resistant sheet 14 and roofing membrane 16 are rolled together to form a single membrane assembly, which is in the form of a roll, prior to shipment to an installation site. Rolling of the fire-resistant sheet 14 and roofing membrane 16 together may be performed by any method known to those skilled in the art. In one or more embodiments, the fire-resistant sheet 14 and roofing membrane 16 may first be positioned in a planar overlapping arrangement and then rolled. In other embodiments, fire-resistant sheet 14 and roofing membrane 16 may each be drawn from a separate roll while being simultaneously rolled together. In certain embodiments, roofing membrane 16 and fire-resistant sheet 14 are rolled together in the longitudinal direction so that the width of each defines the width of the membrane assembly roll.

In one or more embodiments, fire-resistant sheet 14 may be secured to roofing membrane 16 prior to rolling and shipment to an installation site. In certain embodiments, fire-resistant sheet 14 may be secured to roofing membrane 16 by lamination. The lamination process may include heating of the laminate to facilitate bonding of the fire-resistant sheet to the roofing membrane. Other known methods of securing fire-resistant sheet 14 to roofing membrane 16 may also be employed, including, for example, use of an adhesive.

### Method of Installing Roofing System

After being shipped to an installation site, the membrane assembly may be unrolled on a roof deck so that the fire-resistant sheet 14 is positioned adjacent to the roof deck 12. Thus, the fire-resistant sheet 14 and the roofing membrane 16 are simultaneously positioned on the roof deck thereby eliminating a step required by conventional installation methods and systems. That is, membrane 16 and sheet 14 are simultaneously positioned on the roof deck in the arrangement that they will exist within the roof system, which is an arrangement where membrane 16 is positioned over sheet 14.

Once positioned on roof deck 12, fire-resistant sheet 14 and roofing membrane 16 may be secured to roof deck 12 by conventional attachment mechanisms such as, for example, mechanical fasteners. Similarly, roofing membrane 16 may be secured to adjacent roofing membranes to form lap seams using conventional methods or mechanisms, such as, for example, by using adhesive tape or by heat welding.

During installation of a staggered roofing membrane assembly 18, as described above and shown in FIG. 3, the trailing portion 34 of fire-resistant sheet 14 is positioned under a portion of the fire-resistant sheet 14′ of an adjacent roofing membrane assembly 18′. In this way, as shown in FIG. 4, the exposed portion 32′ of the bottom surface of roofing membrane 16′ may be adhered to the adjacent roofing membrane 16 along the second longitudinal edge 25 thereof. The overlapping of fire-resistant sheets 14 and 14′ at the lap seam 40 of roof system 10 helps to improve the fire resistance of the system.

Installation of the membrane assembly according to the present invention provides a roof system 10 having several advantages. In one or more embodiments, roof system 10 may be a Class A roofing covering system according to the standards set forth in ASTM E-108/UL 790. In other embodiments, roof system 10 may be a Class B roofing covering system according to the standards set forth in ASTM E-108/UL 790.

Various modifications and alterations that do not depart from the scope and spirit of this invention will become apparent to those skilled in the art. This invention is not to be unduly limited to the illustrative embodiments set forth herein.

1. A membrane assembly comprising:
(a) a generally planar membrane having a top surface, a bottom surface, a first longitudinal edge and a second longitudinal edge; and
(b) a generally planar fire-resistant sheet positioned adjacent to and in contact with said bottom surface of said membrane.

2. The membrane assembly of claim 1, wherein said fire-resistant sheet includes a fabric substrate and a binder.

3. The membrane assembly of claim 2, wherein the binder is selected from the group consisting of acrylic latex, butyl rubber latex, SBR latex, neoprene latex, polyvinyl alcohol emulsion and elastomers, vinyl chloride copolymers, nitrile rubbers and polyvinyl acetate copolymers.

4. The membrane assembly of claim 1, further comprising an exposed portion of the bottom surface of the roofing membrane extending longitudinally adjacent the first longitudinal edge of the roofing membrane.

5. The membrane assembly of claim 4, wherein the fire-resistant sheet is narrower than the roofing membrane, thereby providing the exposed portion of the bottom surface of the roofing membrane.

6. The membrane assembly of claim 4, wherein the fire-resistant sheet is off-set relative to the roofing membrane in a transverse direction creating the exposed portion of the bottom surface of the membrane and a trailing edge of the fire-resistant adjacent the second longitudinal edge of the roofing membrane.

7. The membrane assembly of claim 1, wherein the fire-resistant sheet is heat welded to the roofing membrane.

8. The membrane assembly of claim 1, where in the fire-resistant sheet is laminated to the roofing membrane.

9. The membrane assembly of claim 1, where the membrane and sheet are combined in a roll.

10. The membrane assembly of claim 1, wherein the fire-resistant sheet is adhered to the roofing membrane with an adhesive.

11. The membrane assembly of claim 2, wherein the binder includes at least one fire retardant filler selected from the group consisting of fly ash, clay decabromo-diphenyloxide, antimony trioxide, charged calcium carbonate, 3-X mineralite mica, glass and ceramic microspheres.

12. The membrane assembly of claim 2, wherein the roofing membrane is EPDM based.

13. The membrane assembly of claim 2, wherein the fabric substrate includes coated fiberglass.

14. A rolled roofing membrane assembly for transport to and installing on a roof, the membrane assembly comprising:
(a) a waterproof roofing membrane having a top surface, a bottom surface, a first longitudinal edge and a second longitudinal edge opposite the first longitudinal edge; and
(b) a fire-resistant sheet positioned adjacent to and in contact with the bottom surface of the waterproof roofing membrane,
wherein the waterproof roofing membrane and the adjacent fire-resistant sheet are rolled together to form the rolled roofing membrane.

15. The assembly of claim 14, wherein the fire resistant sheet includes a fabric substrate and a binder.

16. The assembly of claim 14, further comprising an exposed portion of the bottom surface of the roofing membrane extending longitudinally adjacent the first longitudinal edge of the roofing membrane.

17. The assembly of claim 15, wherein the fire resistant sheet is heat welded to the roofing membrane.

18. A method of manufacturing a roofing membrane assembly comprising:
(a) providing a roofing membrane;
(b) providing a fire resistant sheet;
(c) positioning the fire resistant sheet adjacent to the roofing membrane; and
(d) rolling the roofing membrane and fire resistant sheet together to form a rolled roofing membrane assembly.

19. The method of claim 18, further comprising the step of securing the fire resistant sheet to the roofing membrane prior to the step of rolling.

20. The method of claim 18, wherein the step of positioning the fire resistant sheet includes placing the fire resistant sheet so that it is off-set from the roofing membrane along a longitudinal edge thereof.
